(19) United States
(12) Patent Application Publication
(10) Pub. No.: US 2008/0111495 A1
(43) Pub. Date: May 15, 2008

(54) Energy recovery circuit of display panel and apparatus for driving display panel including the same

(76) Inventors: Sun-Kyung Ahn, Suwon-si (KR); Kwang-Ho Jin, Suwon-si (KR); Sang-Young Lee, Suwon-si (KR); Jung-Jin Choi, Suwon-si (KR)

Correspondence Address: ROBERT E. BUSHNELL, 1522 K STREET NW, SUITE 300, WASHINGTON, DC, 20005-1202, US

(21) Appl. No.: 11/698,168

(22) Filed: Jan. 26, 2007

(30) Foreign Application Priority Data
Nov. 10, 2006 (KR) 10-2006-0111249

(51) Int. Cl. G09G 3/288; H02J 7/00

(52) U.S. Cl. 315/169.4; 320/103

(57) ABSTRACT

Provided is an energy recovery unit of a display panel having a panel capacitor. The panel capacitor is formed between any two electrodes of the display panel. The energy recovery unit includes an energy storage unit that stores charges transferred from the panel capacitor. The energy storage unit includes a first storage device that stores charges transferred from the panel capacitor, and a second storage device that additionally stores charges transferred from the panel capacitor. The energy storage unit further includes a current ripple reduction device that reduces current ripple generated in the energy recovery unit. The current ripple device is coupled to both of the first and the second storage devices.

### CLAIM OF PRIORITY

This application makes reference to, incorporates the same herein, and claims all benefits accruing under 35 U.S.C. §119 from an application for ENERGY RECOVERY CIRCUIT OF DISPLAY PANEL AND DRIVING APPARATUS THEREWITH earlier filed in the Korean Intellectual Property Office on the 10 Nov. 2006 and there duly assigned Serial No. 10-2006-0111249.

### BACKGROUND OF THE INVENTION

1. Field of the Invention

The present invention relates to an energy recovery circuit of a display panel and apparatus for driving the display panel including the same, and more particularly, to an energy recovery circuit of a display panel that stores energy in an energy recovery capacitor or applies a pulse waveform voltage to electrode lines using the energy stored in the energy recovery capacitor so as to drive the display panel, and apparatus for driving the display panel including the energy recovery circuit.

2. Description of the Related Art

Plasma display panels (PDPs) have become popular because they can be easily. manufactured as large-sized flat panel displays. A PDP displays images using a discharge phenomenon. Generally, plasma display panels can be classified into DC type plasma display panels and AC type plasma display panels according to the type of driving signals. Since DC type plasma display panels have a disadvantage that they requires a long discharge delay time, current development mainly focuses on AC type PDPs.

One type of AC-type PDPs is a 3-electrode AC surface discharge PDP, which includes three electrode groups and is driven by AC voltages. Because a 3-electrode surface discharge PDP is thinner and lighter than a cathode-ray tube (CRT), the 3-electrode surface discharge PDP has an advantage that it can realize a large size screen with relatively smaller volume.

A 3-electrode surface discharge type PDP and a driving apparatus and method thereof are disclosed in U.S. Pat. No. 6,744,218 entitled “Method of Driving a Plasma Display Panel in which the Width of Display Sustain Pulse Varies”. The PDP and the driving apparatus and method thereof, which are disclosed in U.S. Pat. No. 6,744,218, are incorporated in the present application and a detailed description thereof is omitted.

The PDP disclosed above includes a plurality of display cells which are intersections of sustain electrodes and address electrodes. Each display cell consists of three (red, green, and blue) discharge cells, and a gray scale of an image is achieved by adjusting discharge states of the discharge cells.

In order to achieve a gray scale of a PDP, a frame, which is a display cycle, is divided into a plurality of subfields. For example, each frame can be divided into 8 subfields. Each subfield has different light-emitting time period. With the 8 subfields, 256 gray scales can be realized. In this case, a frame period of 1/60 second, which is 16.67 ms, is divided into 8 subfields. Each subfield is again divided into a reset period, an address period, and a sustain discharge period to drive the PDP.

In the reset period, all discharge cells are initialized. In the address period, discharge cells that will display images are selected. In the sustain discharge period, sustain discharges are generated in the discharge cells selected during the address period.

During an operation of PDP, voltage higher than a discharge firing voltage of a discharge gas is continuously applied between sustain electrodes disposed in the discharge cells. The sustain electrodes (X electrodes and Y electrodes) are coated with a dielectric substance so that panel capacitors, having predetermined amounts of capacitance, are formed on the X electrodes and Y electrodes.

Therefore, when the PDP is driven by alternately applying positive and negative voltages between the sustain electrodes, the panel capacitors are continuously charged and discharged. The panel capacitor consumes a great amount of reactive power during the operation of charging and discharging. The panel capacitor also generates noise while the capacitor is repeatedly charged and discharged.

### SUMMARY OF THE INVENTION

The present invention provides an energy recovery circuit of a display panel capable of reducing noise and current ripple using a current ripple reduction member connected to an energy recovery terminal, and apparatus for driving the display panel including the same.

According to an aspect of the present invention, there is provided an energy recovery unit of a display panel that has a panel capacitor. The energy recovery unit includes a first storage device storing charges transferred from the panel capacitor, a second storage device coupled to the first storage device, and a current ripple reduction device coupled to both of the first storage device and the second storage device. The second storage device additionally stores charges transferred from the panel capacitor. The current ripple reduction device reduces current ripple generated in the energy recovery unit.

The first storage device and the second storage device can be capacitors. The first storage device can be a film capacitor, and the second storage device can be an electrolysis capacitor. Capacitance of the second storage device can be greater than capacitance of the first storage device.

The current ripple reduction device can include at least two diodes that are connected in parallel and in opposite directions to each other. The current ripple reduction device can include an impedance device. The current ripple reduction device can include a resistor or an inductor.

The first storage device and the second storage device can be connected in parallel. The first storage device can be connected between the panel capacitor and the second storage device. The current ripple reduction device can be connected between the first storage device and the second storage device.

According to another aspect of the present invention, there is provided an energy recovery circuit of a display panel that has a panel capacitor. The energy recovery unit includes an energy storage unit, which includes a first storage device storing charges transferred from the panel capacitor, and a second storage device coupled to the first storage device. The second storage device additionally stores charges transferred from the panel capacitor.

The energy storage unit further can include a current ripple reduction device coupled to both of the first storage device and the second storage device. The current ripple reduction device reduces current ripple generated in the energy recovery unit.

The energy recovery circuit can further includes an energy recover switching unit coupled to the energy storage unit, and a resonance inductor connected between the panel capacitor and the energy storage unit. The energy recovery switching unit transfers charges from the panel capacitor to the energy storage unit, and supplies charges from the energy storage unit to the panel capacitor.

The resonance inductor is connected between the panel capacitor and the energy recovery switching unit, and the energy recovery switching unit is connected between the resonance inductor and the energy storage unit.

The first storage device can be connected between the second storage device and the energy recovery switching unit, and the first storage device and the second storage device can be connected in parallel. The first storage device can be a film capacitor, and the second storage device can be an electrolysis capacitor. Capacitance of the second storage device can be greater than capacitance of the first storage device.

The current ripple reduction device can be connected between the first storage device and the second storage device. The current ripple reduction device can include at least two diode that are connected in parallel and in opposite directions to each other. The current ripple reduction device can be a resistor or an inductor.

The energy recovery switching unit can includes a first control switch having one end connected to the energy storage unit and another end connected to the resonance inductor, a second control switch having one end connected to the energy storage unit and another end connected to the resonance inductor where the first control switch and the second control switch being connected in parallel, a first diode connected between the first control switch and the resonance inductor where the anode of the first diode being connected to the first control switch, and a second diode connected between the second control switch and the resonance inductor where the anode of the second diode being connected to the resonance inductor.

The energy recovery circuit can further includes an energy charging unit coupled to the energy storage unit for supplying power to the energy storage unit. The energy charging unit includes at least two impedance devices that are connected in series between a power source and a ground terminal. The energy charging unit applies voltages to the energy storage unit where the magnitude of the voltage is determined by the impedances of the impedance devices. The impedance devices can be resistors. The energy charging unit can supply a half of a voltage that is necessary for the panel capacity to display an image. The resonance inductor resonates when the panel capacitor is charged and discharged.

According to another aspect of the present invention, there is provided an apparatus for driving a a plasma display panel having a panel capacitor. The apparatus includes an image processor for converting external analog image signals into digital signals and for generating internal image data signals, a logic controller coupled to the image processor where the logic controller generates driving control signals from the internal image data signals received from the image processor, an address driver coupled to the logic controller where the address driver generates an address driving signal, a X driver coupled to the logic controller where the X driver generates a X driving signal, a Y driver coupled to the logic controller where the Y driver generates a Y driving signal, and an energy recovery unit coupled to one of the address driver, the X driver, and the Y driver. The energy recovery unit can includes a first storage device storing charges transferred from the panel capacitor, a second storage device coupled to the first storage device where the second storage device additionally storing charges transferred from the panel capacitor, and a current ripple reduction device coupled to both of the first storage device and the second storage device. The current ripple reduction device reduces current ripple generated in the energy recovery unit.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a 3-electrode surface discharge plasma display panel (PDP) to which a plasma display panel driving apparatus, which is constructed as an embodiment of the present invention, is applied;

FIG. 2 is a block diagram showing a driving apparatus for driving the PDP illustrated in FIG. 1;

FIG. 3 is a diagram showing driving signals as a function of time, which are outputted from an address driver, X driver, and Y driver shown in FIG. 2;

FIG. 4 is a circuit diagram of the X driver shown in FIG. 2 constructed as an embodiment of the present invention;

FIG. 5 is a circuit diagram of the Y driver shown in FIG. 2 constructed as an embodiment of the present invention;

FIGS. 6, 8, and 10 are circuit diagrams schematically illustrating diodes, inductors, and resistors used in current ripple reduction devices of energy storage units illustrated in FIGS. 4 and 5, which are constructed as embodiments of the present invention; and

FIGS. 7, 9, and 11 are graphs showing current reduction effects acquired from the circuits of FIGS. 6, 8, and 10, which are constructed as embodiments of the present invention.

### DETAILED DESCRIPTION OF THE INVENTION

The present invention will now be described more completely with reference to the accompanying drawings, in which exemplary embodiments of the invention are shown.

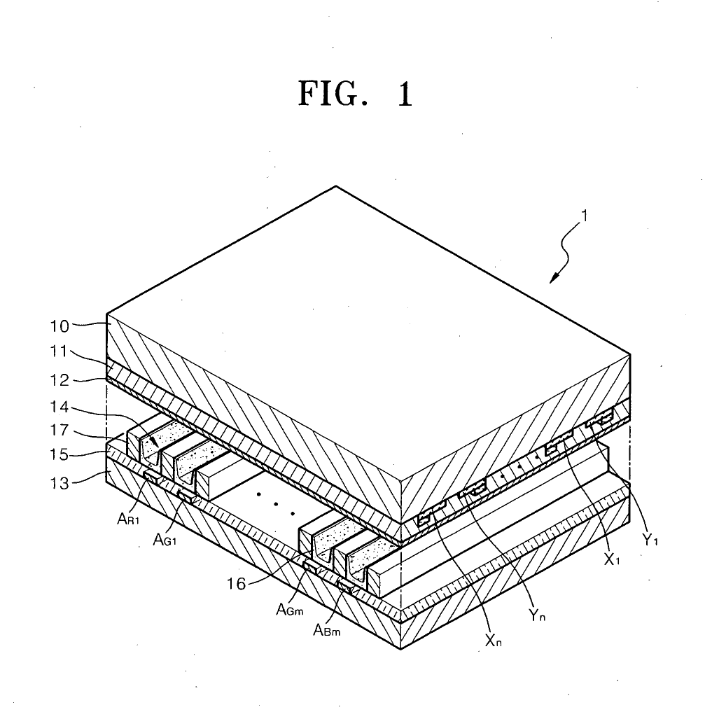

FIG. 1 is a perspective view of 3-electrode surface discharge plasma display panel (PDP) 1 to which a plasma display panel driving apparatus of an embodiment of the present invention is applied. Referring to FIG. 1, address electrode lines A_{R1} through to A_{Bm}, upper and lower dielectric layers 11 and 15, Y electrode lines Y₁ through to Yₙ, X electrode lines X₁ through to Xₙ, phosphor layers 16, barrier ribs 17, and a protection layer 12, which can be made of magnesium oxide (MgO), are formed between front and rear glass substrates 10 and 13.

Address electrode lines A_{R1} through to A_{Bm} are formed in a predetermined pattern on an upper surface of rear glass substrate 13. Lower dielectric layer 15 covers address electrode lines A_{R1} through to A_{Bm}. Barrier ribs 17 are formed parallel to address electrode lines A_{R1} through to A_{Bm} on a surface of lower dielectric layer 15. Barrier ribs 17 partition a space, which is formed between front and rear glass substrates 10 and 13, into a plurality of discharge areas, and prevent cross talk between the discharge areas. Phosphor layers 16 are formed on sidewalls of barrier ribs 17 and on a surface of lower dielectric layer 15.

X electrode lines X₁ through to Xₙ and Y electrode lines Y₁ through to Yₙ are formed in predetermined patterns on a lower surface of front glass substrate 10 in a manner that X electrode and Y electrode lines cross address electrode lines A_{R1} through to A_{Bm}. Discharge cells 14 are defined as intersections where X electrode lines X₁ through to Xₙ and Y electrode lines Y₁ through to Yₙ intersect address electrode lines A_{R1} through to A_{Bm}. Each of X electrode lines X₁ through to Xₙ and each of Y electrode lines Y₁ through to Yₙ is formed by coupling a transparent conductive electrode made of a material such as Indium Tin Oxide (ITO) with a metal electrode for increasing conductivity.

For each of discharge cells 14, a X electrode line is a common electrode, a Y electrode line is a scan electrode, and an address electrode line is an address electrode.

A panel capacitor can be formed between two or more electrode lines depending on a display cycle. The two or more electrodes lines can be address electrode lines A_{R1} through to A_{Bm}, Y electrode lines Y₁ through to Yₙ and X electrode lines X₁ through to Xₙ.

Voltages are applied to address electrode lines A_{R1} through to A_{Bm}, Y electrode lines Y₁ through to Yₙ and X electrode lines X₁ through to Xₙ in order to drive the PDP 1. Therefore, a panel capacitor can be formed between Y electrode lines Y₁ through to Yₙ and X electrode lines X₁ through to Xₙ during a sustain discharge period, and can be formed between address electrode lines A_{R1} through to A_{Bm} and Y electrode lines Y₁ through to Yₙ during an address period.

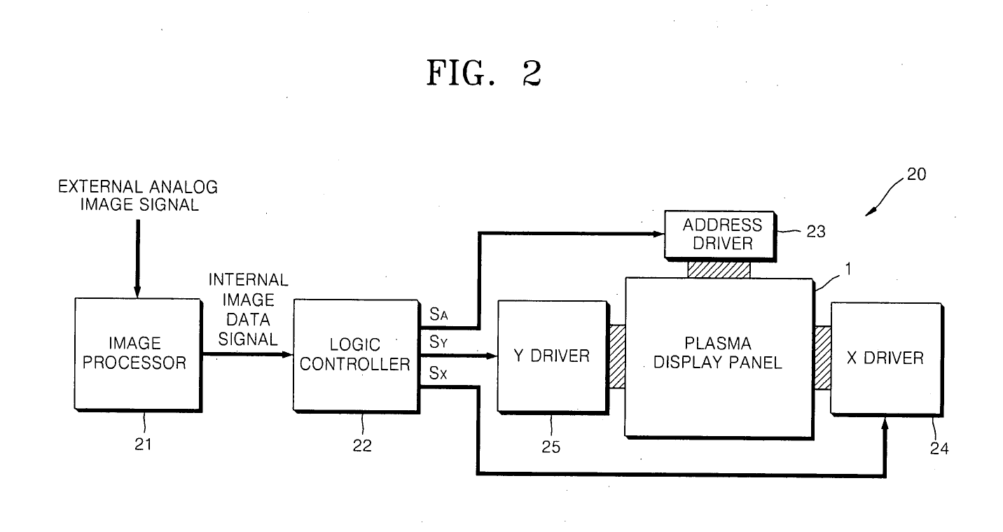

FIG. 2 is a block diagram showing driving apparatus 20 for driving PDP 1 illustrated in FIG. 1. Referring to FIG. 2, PDP driving apparatus 20 includes image processor 21, logic controller 22, address driver 23, X driver 24, and Y driver 25. Image processor 21 converts external analog image signals into digital signals, and generates internal image data signals such as red (R), green (G), and blue (B) image data signals, a clock signal, and vertical and horizontal synchronization signals. Logic controller 22 generates driving control signals S_{A}, S_{Y}, and S_{X} according to the internal image data signals received from image processor 21. Address driver 23, X driver 24, and Y driver 25 receive driving control signals S_{A}, S_{X}, and S_{Y}, respectively, and generate corresponding address, X, and Y driving signals. Address driver 23, X driver 24, and Y driver 25 applies the generated corresponding driving signals to address electrode lines, X electrode lines, and Y electrode lines, respectively.

Address driver 23 applies a display data signal through address driving control signal SA received from logic controller 22 to the address electrode lines. X driver 24 processes X driving control signal S_{X} received from logic controller 22, and applies a voltage signal corresponding to X driving control signal S_{X} to the X electrode lines. Y driver 25 processes Y driving control signal S_{Y} received from logic controller 22, and applies a voltage signal corresponding to Y driving control signal S_{Y} to the Y electrode lines.

Each of address driver 23, X driver 24, and Y driver 25 can includes an energy recovery circuit. The energy recovery circuit included in each of the drivers can store energy supplied from the panel capacitor to an energy storage unit, or can supply energy stored in the energy storage unit to the panel capacitor. When a voltage pulse is applied to the electrode lines, the energy recovery unit can minimize hard switching.

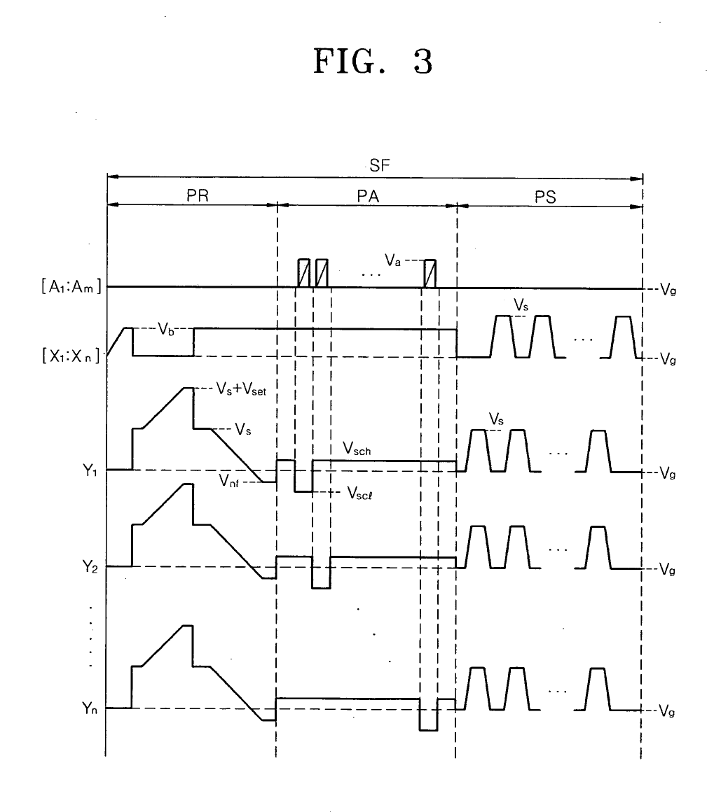

FIG. 3 is a diagram of driving signals, which are outputted from each of the drivers of PDP 1 illustrated in FIG. 2, in a subfield of a frame. Referring to FIG. 3, a unit frame for driving plasma display panel 1 is divided into a plurality of subfields to achieve time division gray scale. Subfield SF includes reset period PR, address period PA, and sustain discharge period PS.

In reset period PR, a reset pulse including a rising pulse and a falling pulse is applied to Y electrodes Y₁ through Yₙ, and a second voltage (a bias voltage) is applied to X electrodes X₁ through Xₙ to perform a reset discharge. The reset discharge initializes all discharge cells. The voltage of rising pulse increases with time from sustain discharge voltage Vs to peak reset voltage Vset+Vs by an amount of Vset. The voltage of the falling pulse decreases with time from sustain 14 discharge voltage Vs to a lowest rest voltage Vnf.

In address period PA, a scan pulse is sequentially applied to Y electrodes Y₁ through Yₙ, and a display data signal is applied to address electrodes A₁ through Aₘ in accordance with the scan pulse to generate an address discharge. During address period PA, discharge cells, which are to generate sustain discharges in the sustain discharge period PS, can be selected. The scan pulse has a high scan voltage Vsch and a low scan voltage Vscl. The display data signal has a positive address pulse voltage Va, which is coincidentally applied with low scan voltage Vscl of the scan pulse.

In sustain discharge period PS, sustain pulses are applied to the X electrodes X₁ through Xₙ and Y electrodes Y₁ through Yₙ to generate a sustain discharge. The sustain discharge is generated in the discharge cells that are selected during address period PA. During sustain-discharge period, visible light is generated, and the brightness of the light is determined by a gray level selected for this time period. The gray level can be controlled by changing combinations of subfields that produces sustain discharge. The gray level is determined by a number of subfields that produces the sustain discharge and by a kind of subfield that produces the sustain discharge.

According to the present embodiment of the present invention, the driving signals illustrated in FIG. 3 are not necessarily limited thereto, and other driving signals can be used instead of the driving signals shown in FIG. 3.

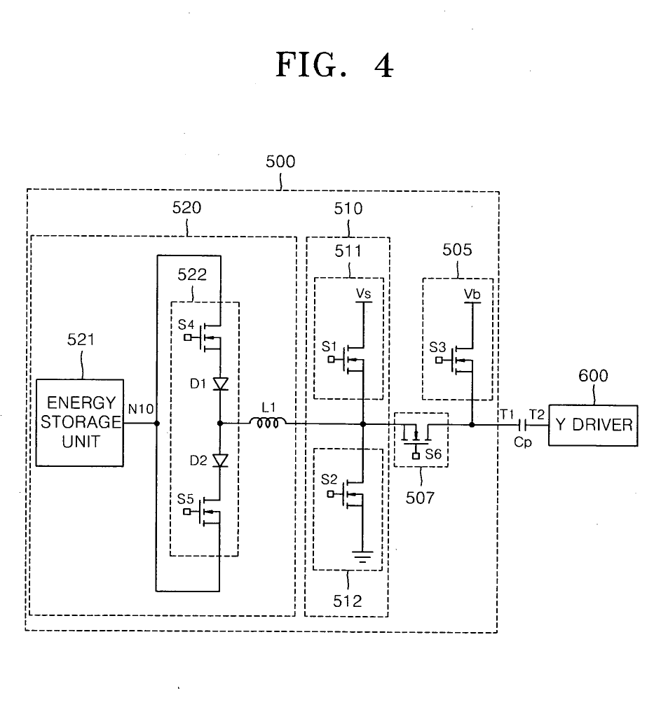

FIG. 4 is a circuit diagram showing first driver 500, which can be X driver 24 of the apparatus for driving the PDP illustrated in FIG. 2, which is constructed as an embodiment of the present invention. Referring to FIG. 4, the apparatus for driving the PDP includes sustain pulse applying circuit of X driver 510, second voltage applying unit of X driver 505, energy recovery circuit of X driver 520, and switching unit of X driver 507. In the present embodiment, sustain pulse applying circuit of X driver 510 outputs a driving signal to X electrodes. In FIG. 4, X electrode is represented as first terminal T1, while Y electrode is represented as second terminal T2. As described above, voltages are applied to the address electrode lines, the Y electrode lines, and the X electrode lines during address discharge and sustain discharge. A space between two electrodes can form a capacitor. Therefore, a panel capacitor is defined as a portion of an intersection area at which a X electrode and a Y electrode intersect with an address electrode. The intersection area can be referred to as a pixel, and the pixel is included in a discharge cell, because discharge cells are defined as intersections where X electrode lines X₁ through to Xₙ and Y electrode lines Y₁ through to Yₙ intersect address electrode lines A_{R1} through to A_{Bm}. Because visible light is produced in the discharge cells, a pixel is a basic unit for displaying an image. Panel capacitor Cp schematically represents a pixel or pixels at which a X electrode electrically interacts with a Y electrode, or schematically represents a pixel at which an address electrode electrically interacts with a Y electrode or a X electrode.

Sustain pulse applying circuit of X driver 510 includes first voltage applying unit of X driver 511 that outputs first voltage (sustain discharge voltage) Vs, and ground voltage applying unit of X driver 512 that outputs ground voltage Vg, in order to output a driving signal to the X electrodes represented by first terminal T1 of panel capacitors Cp. Second voltage applying unit of X driver 505 outputs second voltage Vb. The energy recovery unit of X driver 520 accumulates charges transferred from panel capacitor Cp, or supplies charges to panel capacitor Cp.

First voltage applying unit of X driver 511 includes first switching device S1 having one terminal connected to first voltage source Vs and another terminal connected to switching unit 507. Ground voltage applying unit of X driver 512 includes second switching device S2 having one terminal connected to ground and another terminal connected to switching unit of X driver 507. Sustain pulse applying unit of X driver 510 alternately turns on the first switching device S1 and the second switching device S2 in order to alternately apply voltage supplied from first voltage applying unit of X driver 511 and ground voltage applying unit of X driver 512.

Second voltage applying unit of X driver 505 includes third switching device S3 having one terminal connected to second voltage source Vb and another terminal connected to the X electrodes (first terminal T1 of panel capacitor Cp) of the PDP. If third switching device S3 is turned on, second voltage Vb is outputted to the X electrodes of the PDP.

Energy recovery unit of X driver 520 includes energy storage unit of X driver 521 that stores charges transferred from panel capacitor Cp, energy recovery switching unit of X driver 522, and resonance inductor L1. Energy recovery switching unit of X driver 522 is connected to energy storage unit of X driver 521, and controls processes of storing charges in energy storage unit of X driver 521 or supplying charges to panel capacitor Cp. Resonance inductor L1 has one end connected to energy recovery switching unit of X driver 522 and another end connected to the X electrodes of the PDP.

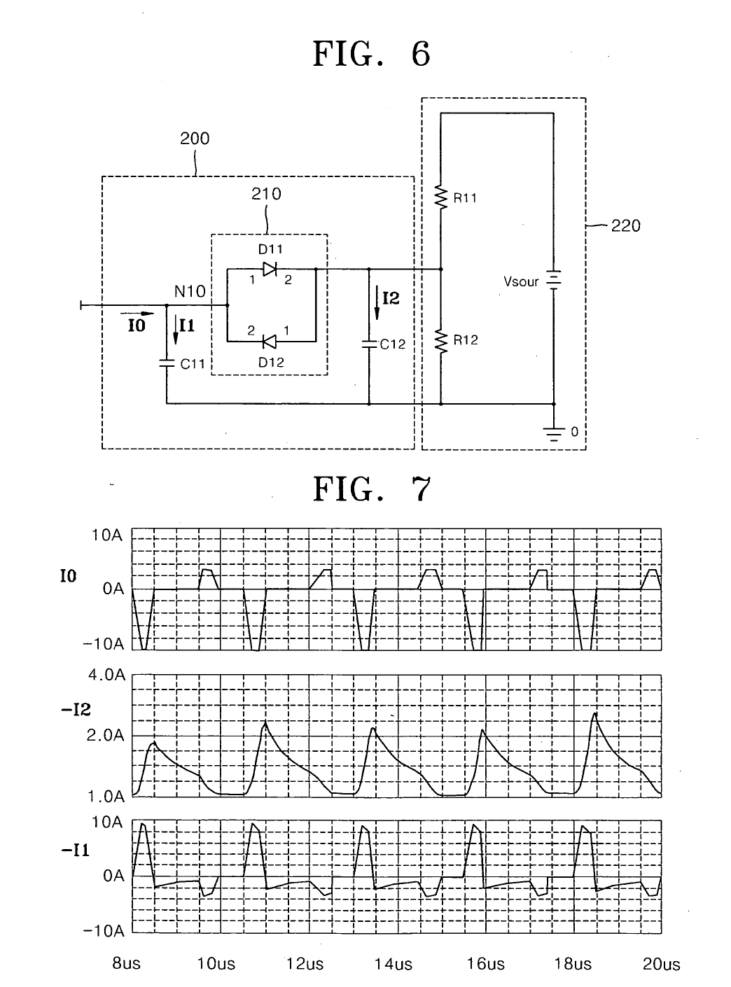

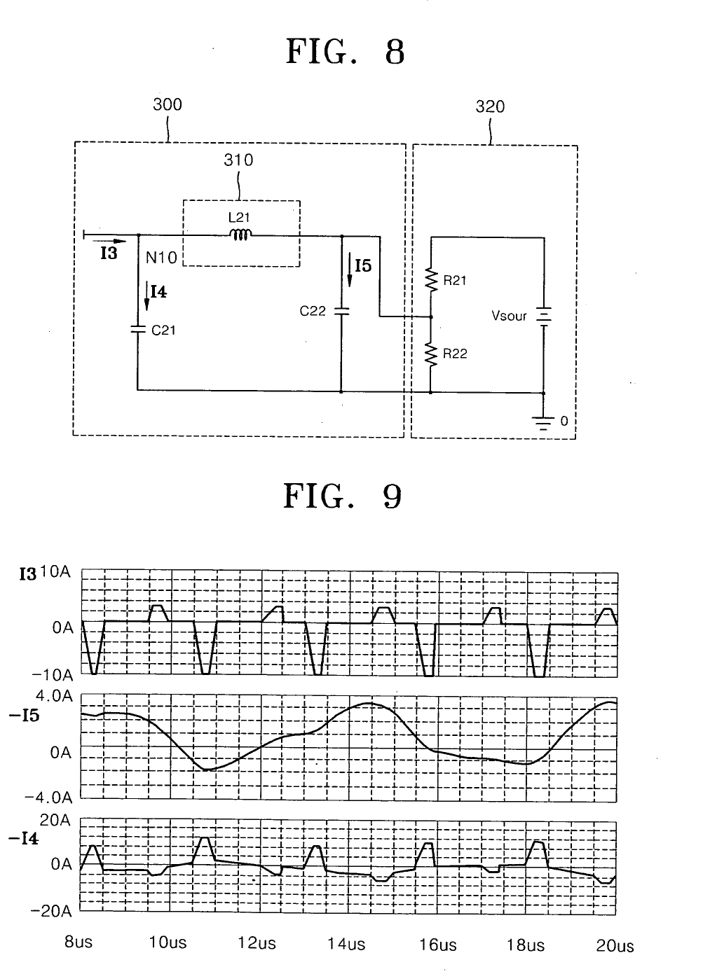

Energy storage unit of X driver 521 can includes a capacitor for storing the charges transferred from panel capacitor Cp. Energy storage unit of X driver 521 can be one of first, second, and third energy storage units 200, 300, and 400 shown in FIGS. 6, 8, and 10, respectively. Energy recovery unit of X driver 520 can be an energy recovery circuit, and further includes energy charging units 220, 320, and 420 shown in FIGS. 6, 8, and 10, respectively.

Energy recovery switching unit of X driver 522 includes fourth switching device (first control switch) S4 and fifth switching device (second control switch) S5, each of which has one terminal connected to input terminal N10 and another terminal connected to resonance inductor L1. First and second diodes D1 and D2 are provided between fourth switching device S4 and fifth switching device S5. First and second diodes D1 and D2 are arranged in opposite directions from resonance inductor L1.

As well known in the art, a diode has a anode and a cathode, and electric current can flow only from the anode to the cathode of the diode. Herein, a direction of a diode is defined as a direction from the anode to the cathode. Therefore, if two diodes are arranged or connected in opposite directions, the relative positions of anodes with respect to the cathodes of the diodes are opposite. In this specification, the meaning of “being connected between” is defined as follows. If a first element is connected or coupled between a second element and a third element, the second element is connected or coupled to the third element through the first element. Therefore in this case, if electric current, for example, is flowing from the second element to the third element, the current is first flowing from the second element to the first element, and then is flowing from the first element to the third element. In this case, the first element does not need to be physically located between the second and the third elements. In the other words, the term of connection or coupling is not related to physical locations of elements.

During the operation of energy recovery unit of X driver 520, if fifth switching device S5 of energy recovery switching unit of X driver 522 is turned on, the charges of panel capacitor Cp are transferred to energy storage unit of X driver 521 through resonance inductor L1, second diode D2, and fifth switching device S5. If fourth switching device S4 is turned on, the charges stored in energy storage unit of X driver 521 are supplied to panel capacitors Cp through fourth switching device S4, first diode D1, and resonance inductor L1.

When sustain discharge voltage Vs of the sustain pulse is applied, charges stored in energy storage unit of X driver 521 is first supplied to the X electrode. As charges are supplied from energy storage unit of X driver 521, voltage increases from the level of ground voltage Vg to the level of sustain discharge voltage Vs or a level close to sustain discharge voltage Vs. After the voltage applied to each electrode line reaches the level of sustain discharge voltage Vs or to a predetermined level close to sustain discharge voltage Vs, sustain discharge voltage Vs is applied to each electrode line from sustain pulse applying circuit of X driver 510. Therefore, switching load and reactive power consumption are reduced and thus the energy can be efficiently used.

When ground voltage Vg of the sustain pulse is applied, charges accumulated in panel capacitors Cp is first transferred to energy storage unit of X driver 521, and thus a voltage that is applied to each electrode line falls from sustain discharge voltage Vs to the level of ground voltage Vg or to a level close to ground voltage Vg. After the voltage applied to each electrode line falls to the level of ground voltage Vg or to a predetermined level close to ground voltage Vg, ground I1 voltage Vg is applied to each electrode line from ground voltage applying unit of X driver 512. Therefore, switching load and reactive power consumption are reduced and thus the energy can be efficiently used.

Switching unit 507 has one end connected to sustain pulse applying unit of X driver 510 and another end connected to second voltage applying unit of X driver 505, and includes sixth switching device S6. Switching unit of X driver 507 performs a switching operation in order to apply the sustain pulse output from sustain pulse applying unit of X driver 510 to the X electrodes of the PDP, and to prevent second voltage Vb outputted from second voltage applying unit of X driver 505 from flowing into sustain pulse applying unit of X driver 510. Sixth switching device S6 is turned on when the sustain pulse is applied to the X electrodes (represented by first terminal T1 of panel capacitors Cp) of the PDP, and sixth switching device is turned off, when the sustain pulse is not applied to the X electrodes, in order to prevent second voltage Vb from flowing into sustain pulse applying unit of X driver 510.

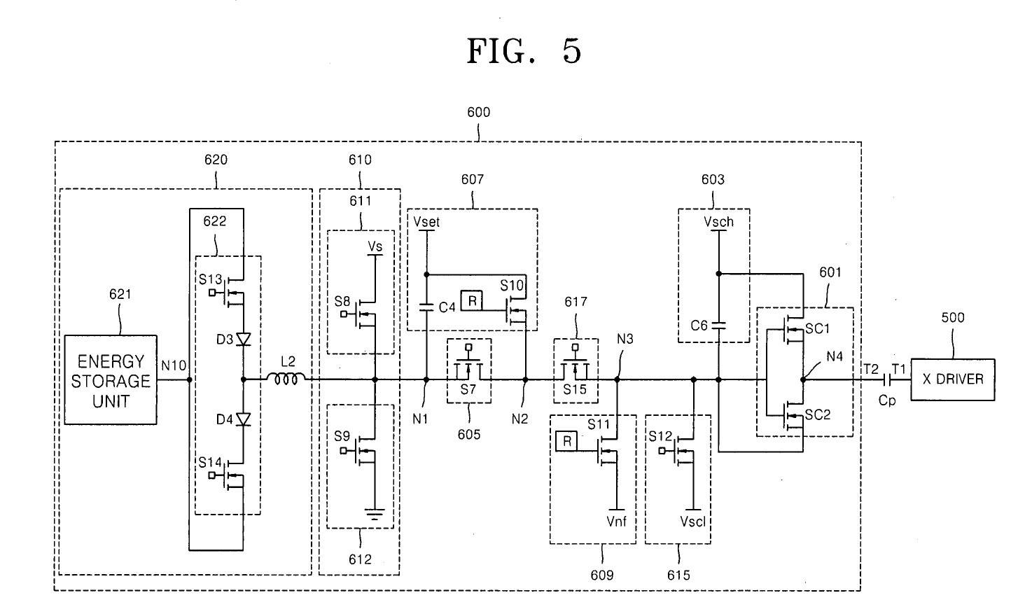

FIG. 5 is a circuit diagram schematically showing second driver 600, which can be Y driver 25 of the apparatus for driving the PDP shown in FIG. 2, which is constructed as an embodiment of the present invention. Referring to FIG. 5, the apparatus for driving the PDP of the present embodiment includes sustain pulse applying unit of Y driver 610, first switching unit of Y driver 605, second switching unit of Y driver 617, third voltage applying unit of Y driver 607, fourth voltage applying unit of Y driver 609, scan switching unit of Y driver 601, fifth voltage applying unit of Y driver 603, sixth voltage applying unit of Y driver 615, and energy recovery unit of Y driver 620. In the present embodiment, sustain pulse applying circuit of Y driver 610 outputs a driving signal to Y electrodes, which is represented by second terminal T2 of panel capacitor Cp.

Sustain pulse applying unit of Y driver 610 includes first voltage applying unit of Y driver 611 and ground voltage applying unit of Y driver 612. First voltage applying unit of Y driver 611 outputs sustain discharge voltage Vs to first node N1 in order to output the driving signal to the Y electrodes. Ground voltage applying unit of Y driver 612 outputs ground voltage Vg to first node N1.

First switching unit of Y driver 605 includes a seventh switching device S7 having one end connected to first node N1 and another end connected to second node N2. Second switching unit of Y driver 617 includes fifteenth switching device S15 having one end connected to second node N2 and another end connected to third node N3.

Third voltage applying unit of Y driver 607, which is connected between first node N1 and second node N2, gradually increases sustain discharge voltage (first voltage) Vs by third voltage Vset, and outputs the voltage Vs+Vset to second node N2. Fourth voltage applying unit of Y driver 609, which is connected to third node N3, gradually decreases sustain discharge voltage Vs to the level of fourth voltage Vnf, and outputs third voltage Vnf to third node N3.

Scan switching unit of Y driver 601 includes first scan switching device SC1 and second scan switching device SC2, which are connected to each other in parallel. Fourth node N4 is disposed between first scan switching device SC1 and second scan switching device SC2, and is connected to the Y electrodes (second terminals T2 of panel capacitors Cp) of the PDP. Scan switching unit 601 can includes a plurality of scan ICs capable of controlling the application of voltage from a power supply to the Y electrode lines. If the Y electrode lines are divided into a plurality of blocks, each of the blocks can be controlled by each of the scan ICs.

Fifth voltage applying unit of Y driver 603, which includes fifth voltage source, is connected to first scan switching device SC1, and outputs fifth voltage Vsch to first scan switching device SC1. Sixth voltage applying unit of Y driver 615 is connected to third node N3 and the second scan switching device SC2, and outputs sixth voltage Vsc1.

The energy recovery unit of Y driver 620 accumulates charges from panel capacitor Cp or supplies charges to panel capacitor Cp.

First voltage applying unit of Y driver 611 includes eighth switching device S8 having one terminal connected to first voltage source that supplies sustain discharge voltage (first voltage) Vs and another terminal connected to first node N1. Ground voltage applying unit of Y driver 612 includes ninth switching device S9 having a terminal connected to ground and another terminal connected to first node N1. Sustain pulse applying unit of Y driver 610 alternately turns on eight switching device S8 and ninth switching device S9 in order to generate a sustain pulse.

Third voltage applying unit of Y driver 607 includes fourth capacitor C4 and tenth switching device S10. One end of fourth capacitor C4 is connected to first node N1, and another end thereof is connected to third voltage source that supplies third voltage Vset. Tenth switching device S10 is connected between third voltage source that supplies Vset and second node N3.

Fourth voltage applying unit of Y driver 609 includes eleventh switching device S11 having one end connected to third node N3 and another end connected to fourth voltage source that supplies fourth voltage Vnf. If eighth switching device S8 of first voltage applying unit of Y driver 611, seventh switching device S7 of first switching unit of Y driver 605, fifteenth switching device S15 of second switching unit of Y driver 617, and eleventh switching device S11 of fourth voltage applying unit of Y driver 609 are turned on, voltage gradually falls from the level of first voltage Vs to the level of fourth voltage Vnf, and is output to third node N3.

Sixth voltage applying unit of Y driver 615 includes twelfth switching device S12 connected between third node N3 and sixth voltage source that supplies sixth voltage Vsc1. If twelfth switching device S12 is turned on, sixth voltage Vsc1 is outputted to third node N3.

If first scan switching device SC1 of the scan switching unit of Y driver 601 is turned on and second scan switching device SC2 thereof is turned off, fifth voltage Vsch is outputted to the Y electrodes through fourth node N4. If first scan switching device SC1 of the scan switching unit of Y driver 601 is turned off and second scan switching device SC2 thereof is turned on, voltage, which is outputted to third node N3 including first voltage Vs, ground voltage Vg, fourth voltage Vnf, and sixth voltage Vsc1, is outputted to the Y electrodes (second terminal T2 of panel capacitor Cp) through fourth node N4.

The energy recovery unit of Y driver 620 includes energy storage unit of Y driver 621, energy recovery switching unit of Y driver 622, and second resonance inductor L2. Energy storage unit of Y driver 621 stores charges transferred from panel capacitors Cp. Energy recovery switching unit of Y driver 622 is connected to energy storage unit of Y driver 621, and controls processes of storing charges into energy storage unit of Y driver 621 and supplying charges to panel capacitors Cp. One end of second resonance inductor L2 is connected to energy recovery switching unit of Y driver 622, and another end thereof is connected to first node N1.

Energy storage unit of Y driver 621 can includes a capacitor for storing the charges transferred from panel capacitors Cp. Energy storage unit of Y driver 621 can be one of energy storage units 200, 300, and 400 shown in FIGS. 6, 8, and 10, respectively. Energy recovery unit of Y driver 620 can be an energy recovery circuit, and further includes energy charging units 220, 320, and 420 shown in FIGS. 6, 8, and 10, respectively.

Energy recovery switching unit of Y driver 622 includes thirteenth switching device S13 and fourteenth switching device S14, each of which has one terminal connected to energy storage unit of Y driver 621 and another terminal connected to second resonance inductor L2. Third and fourth diodes D3 and D4 are provided between the thirteenth switching device S13 and the fourteenth switching device S14. Third and fourth diodes D3 and D4 are arranged in opposite directions from second resonance inductor L2.

When the sustain discharge voltage Vs of the sustain pulse is applied, energy stored in energy storage unit of Y driver 621 is first supplied. Voltage increases from the level of ground voltage Vg to sustain discharge voltage Vs or to a level close to sustain discharge voltage Vs, and the voltage is applied to each electrode line. After the voltage applied to each electrode line reaches the level of sustain discharge voltage Vs or to a predetermined level close to sustain discharge voltage Vs, sustain discharge voltage Vs is applied to each electrode line from first voltage applying unit of Y driver 611. Therefore, switching load and reactive power consumption are reduced, and thus energy can be effectively used.

When ground voltage Vg of the sustain pulse is applied, energy accumulated in the panel capacitors Cp is first transferred to energy storage unit 621, and thus voltage, which that is applied to each electrode line, falls from the level of sustain discharge voltage Vs to the level of ground voltage Vg or to a level close to ground voltage Vg. After the voltage applied to each electrode line falls to the level of ground voltage Vg or to a predetermined level close to ground voltage Vg, ground voltage Vg is applied to each electrode line from ground voltage applying unit of Y driver 612. Therefore, switching load and reactive power consumption are reduced and thus energy can be efficiently used.

FIGS. 6, 8, and 10 are circuit diagrams of embodiments of the present invention, schematically illustrating diodes, inductors, and resistors used in current ripple reduction devices, which can be included in energy storage units 521 and 621 shown in FIGS. 4 and 5, respectively. FIGS. 7, 9, and 11 are graphs showing current reduction effects acquired from the embodiments shown in FIGS. 6, 8, and 10.

Referring to FIGS. 6 through 11, each of energy recovery circuits 520 and 620 shown in FIGS. 4, and 5, respectively, can include first energy storage unit 200, second energy storage unit 300, and third energy storage unit 400. Energy recovery circuits 520 and 62.0 also can includes first energy recovery switching unit 522 and second energy recovery switching unit 622. Energy of panel capacitors Cp is transferred to and stored in energy storage units 200, 300, and 400.

Energy recovery switching units 522 and 622 control the processes of storing the energy supplied from panel capacitors Cp to energy storage units 200, 300, and 400, and the processes of supplying the energy stored in energy storage units 200, 300, and 400 to panel capacitors Cp.

First resonance inductor L1 or second resonance inductor L2 is connected between panel capacitors Cp and one of energy storage units 200, 300, and 400 to form a resonance path to assist the processes of storing and supplying energy.

First energy storage unit 200 includes first storage device of first energy storage unit C11, second storage devices of first energy storage unit C12, and first current ripple reduction devices 210. Second energy storage unit 300 includes first storage device of second energy storage unit C21, second storage device of second energy storage unit C22, and second current ripple reduction devices 310. Third energy storage unit 400 includes first storage device of third energy storage unit C31, second storage devices of third energy storage unit C32, and third current ripple reduction devices 410

The energy of panel capacitor Cp is stored in first storage devices C11, C21, or C31. Second storage devices C12, C22, and C32 are additional storage devices to first storage devices C11, C21, and C31 in order to increase the energy storage capacity of the energy recovery device. Current ripple reduction devices 210, 310, and 410 suppress current variation of energy charged in the second storage devices C12, C22, and C32.

Each of first storage devices C11, C21, and C31 and second storage devices C12, C22, and C32 can be a capacitor. Capacitance of second storage devices C12, C22, and C32 are greater than the capacitance of corresponding first storage devices C11, C21, and C31. First storage devices C11, C21, and C31 can be film capacitors. Second storage devices C12, C22, and C32 can be electrolysis capacitors.

When film capacitors are employed for first storage devices C11, C21, and C31, electrolysis capacitors can be employed for second storage devices C12, C22, and C32 in order to reduce noise due to resonance caused by insufficient current capacity of the film capacitors of C11, C21, and C31.

The capacitance of the first storage device can be increased by connecting more first capacitor in parallel. However, if film capacitors are employed for the first storage device, there is limitations to increase the capacitance of the first storage device. Therefore, in this case, second storage device that employs electrolysis capacitors can be connected in parallel to the first storage device to increase the capacitance of the energy recovery system.

Capacitance of an electrolysis capacitor is usually greater that capacitance of a film capacitor. Therefore, an electrolysis capacitor, employed as a second storage device, can be connected in parallel to a film capacitor, employed as a first storage device, in order to obtain sufficiently high capacitance for the energy storage unit and to reduce noise caused by insufficient current capacity.

High frequency operation is performed through input terminal N10 of each of energy storage units 200, 300, and 400. Since an electrolysis capacitor has a large current capacity, current ripple can focus on the electrolysis capacitor, which can damage the lifetime and the reliability of the capacitor. Therefore, a current ripple reduction device can be disposed between the first storage device and the second storage device.

First current ripple reduction device 210 is disposed between first storage device of first energy storage unit C11 and second storage device of first energy storage unit C12, second current ripple reduction device 310 between first storage device of second energy storage unit C21 and second storage device of second energy storage unit C22, and third current ripple reduction device 410 between first storage device of third energy storage unit C31 and second storage device of third energy storage unit C32.

First current ripple reduction device 210 includes first current ripple reduction diodes D11 and second current ripple reduction diode D12 that are connected in parallel but in opposite directions to each other. Second current ripple reduction device 310 includes an impedance device such as current ripple reduction inductor L21. Third current ripple reduction device 410 includes an impedance device such as current ripple reduction resistor R33.

When diodes D11 and D12 are employed in current ripple reduction device 210, the current ripple caused by high frequency signals can be reduced. The degree of the current ripple reduction effect depends on the response speed of the diodes. The current ripple reduction effect, when diodes are employed in the current ripple reduction device, is shown in FIG. 7. Referring to FIG. 7, with respect to input current I0 of energy storage unit 200, the amount of high frequency component of current I1 of first storage device C11 is reduced less than that of current I2 of second storage device C12.

When inductor L21 is employed in current ripple reduction device 310, the current ripple of the high frequency signals can be reduced according to the characteristics of the inductor. The current ripple reduction effect is shown in FIG. 9. Referring to FIG. 9, with respect to input current I3 of energy storage unit 300, the amount of high frequency component of current I4 of first storage device C21 is reduced less than that of current I5 of second storage device C22.

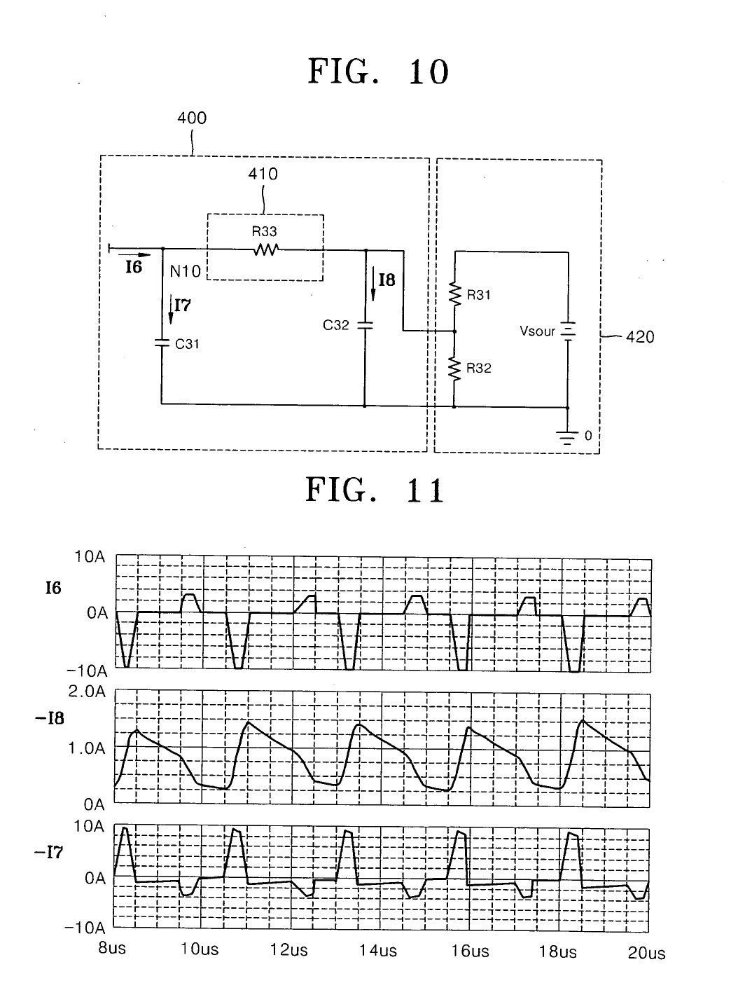

When resistor R33 is employed in current ripple reduction device 410, the current ripple of the high frequency signals can be reduced according to the characteristics of the resistor. The current ripple reduction effect thereof is shown in FIG. 11. Referring to FIG. 11, with respect to input current I6 of energy storage unit 400, the amount of high frequency component of current I7 of first storage device C31 is reduced less than that of current I8 of second storage device C32.

First energy storage unit 200 can further be coupled to first energy charging unit 220, second energy storage unit 300 coupled to second energy charging unit 320, and third energy storage unit 400 coupled to third energy charging unit 420. The energy charging units 220, 320, and 420 supply charged power to energy storage units 300, 400, and 500, respectively.

Each of energy charging units 220, 320, and 420 can charge panel capacitor Cp before panel capacitor Cp is initialized at an initial startup. First energy charging unit 220 includes two impedance devices R11 and R12, which are connected in series from voltage source Vsour. Second energy charging unit 320 includes two impedance devices R21 and R22, which are connected in series between voltage source Vsour and ground terminal 0. Third energy charging unit 420 includes two impedance devices R31 and R32, which are connected in series between voltage source Vsour and ground terminal 0. Each of energy charging units 220, 320, and 420 supplies voltage to energy storage unit through the impedance devices. The magnitude of voltage supplied from voltage source Vsour can be Vs, which is the same as the voltage supplied from first voltage applying units 511 or 611, shown in FIG. 4 or FIG. 5.

The impedance devices R11, R12, R21, R22, R31, and R32 can be resistors as illustrated in FIGS. 6, 8, and 10, or can be capacitors in other embodiments. In order to apply voltage of Vs/2 from voltage source Vsour, the two resistors can have the same resistance, or the two capacitors can have the same capacitance.

Each of energy recovery units 520 and 620 of the present invention can be installed in any of a X driver, a Y driver, or an address driver.

The energy recovery unit of the display panel and apparatus for driving the display panel including the same according to the present invention can reduce noise and current ripple by using a current ripple reduction device installed in an energy storage unit.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An energy recovery unit of a display panel having a panel capacitor, comprising:
a first storage device storing charges transferred from the panel capacitor;
a second storage device coupled to the first storage device, the second storage device additionally storing charges transferred from the panel capacitor; and
a current ripple reduction device coupled to both of the first storage device and the second storage device, the current ripple reduction device reducing current ripple generated in the energy recovery unit.

2. The energy recovery unit of claim 1, wherein each of the first storage device and the second storage device is a capacitor.

3. The energy recovery unit of claim 2, wherein the first storage device is a film capacitor, and the second storage device is an electrolysis capacitor.

4. The energy recovery unit of claim 2, wherein capacitance of the second storage device is greater than capacitance of the first storage device.

5. The energy recovery unit of claim 1, comprised of the current ripple reduction device including at least two diodes that are connected in parallel and in opposite directions to each other.

6. The energy recovery unit of claim 1, comprised of the current ripple reduction device including an impedance device.

7. The energy recovery unit of claim 6, comprised of the current ripple reduction device including a resistor.

8. The energy recovery unit of claim 6, comprised of the current ripple reduction device including an inductor.

9. The energy recovery unit of claim 1, wherein the first storage device and the second storage device are connected in parallel.

10. The energy recovery unit of claim 9, comprised of the first storage device being connected between the panel capacitor and the second storage device.

11. The energy recovery unit of claim 9, comprised of the current ripple reduction device being connected between the first storage device and the second storage device.

12. An energy recovery unit of a display panel having a panel capacitor, comprising:
an energy storage unit comprising:
a first storage device storing charges transferred from the panel capacitor; and
a second storage device coupled to the first storage device, the second storage device additionally storing charges transferred from the panel capacitor.

13. The energy recovery unit of claim 12, comprised of the energy storage unit further including a current ripple reduction device coupled to both of the first storage device and the second storage device, the current ripple reduction device reducing current ripple generated in the energy recovery unit.

14. The energy recovery unit of claim 13, further comprising:
an energy recover switching unit coupled to the energy storage unit; the energy recovery switching unit transferring charges from the panel capacitor to the energy storage unit, and supplying charges from the energy storage unit to the panel capacitor; and
a resonance inductor connected between the panel capacitor and the energy storage unit.

15. The energy recovery unit of claim 14, wherein the resonance inductor is connected between the panel capacitor and the energy recovery switching unit, and the energy recovery switching unit is connected between the resonance inductor and the energy storage unit.

16. The energy recovery unit of claim 15, comprised of the first storage device being connected between the second storage device and the energy recovery switching unit, the first storage device and the second storage device being connected in parallel.

17. The energy recovery unit of claim 16, wherein the first storage device is a film capacitor, the second storage device is an electrolysis capacitor, and capacitance of the second storage device is greater than capacitance of the first storage device.

18. The energy recovery unit of claim 16, comprised of the current ripple reduction device being connected between the first storage device and the second storage device.

19. The energy recovery unit of claim 18, comprised of the current ripple reduction device including at least two diode that are connected in parallel and in opposite directions to each other.

20. The energy recovery unit of claim 19, wherein the current ripple reduction device is a resistor or an inductor.

21. The energy recovery unit of claim 14, wherein the energy recovery switching unit comprises:
a first control switch having one end connected to the energy storage unit and another end connected to the resonance inductor;
a second control switch having one end connected to the energy storage unit and another end connected to the resonance inductor, the first control switch and the second control switch being connected in parallel;
a first diode connected between the first control switch and the resonance inductor, an anode of the first diode being connected to the first control switch; and
a second diode connected between the second control switch and the resonance inductor, an anode of the second diode being connected to the resonance inductor.

22. The energy recovery unit of claim 14, further comprising an energy charging unit coupled to the energy storage unit for supplying power to the energy storage unit.

23. The energy recovery unit of claim 22, wherein the energy charging unit comprises at least two impedance devices that are connected in series between a power source and a ground terminal, and the energy charging unit applies voltages to the energy storage unit where the magnitude of the voltage is determined by the impedances of the impedance devices.

24. The energy recovery unit of claim 23, wherein each of the impedance devices is a resistor.

25. The energy recovery unit of claim 22, wherein the energy charging unit supplies a half of a voltage that is necessary for the panel capacity to display an image.

26. The energy recovery unit of claim 14, wherein the resonance inductor resonates when the panel capacitor is charged and discharged.

27. An apparatus for driving a plasma display panel having a panel capacitor, comprising:
an image processor for converting external analog image signals into digital signals, and for generating internal image data signals;
a logic controller coupled to the image processor, the logic controller generating driving control signals from the internal image data signals received from the image processor;
an address driver coupled to the logic controller, the address driver generating an address driving signal;
a X driver coupled to the logic controller, the X driver generating a X driving signal;
a Y driver coupled to the logic controller, the Y driver generating a Y driving signal; and
an energy recovery unit coupled to one selected from the group consisting of the address driver, the X driver, and the Y driver, the energy recovery unit comprising:
a first storage device storing charges transferred from the panel capacitor;
a second storage device coupled to the first storage device, the second storage device additionally storing charges transferred from the panel capacitor; and
a current ripple reduction device coupled to both of the first storage device and the second storage device, the current ripple reduction device reducing current ripple generated in the energy recovery unit.

28. The apparatus of claim 27, wherein the first storage device is connected between the panel capacitor and the second storage device, and capacitance of the second storage device is greater than capacitance of the first storage device.
